(19) United States
(12) Patent Application Publication
(10) Pub. No.: US 2026/0298768 A1
(43) Pub. Date: Oct. 1, 2026

(54) EVALUATING METHOD OF LENS ARRAY, EVALUATING APPARATUS OF LENS ARRAY, MANUFACTURING METHOD OF OPTICAL APPARATUS, AND MANUFACTURING METHOD OF IMAGE FORMING APPARATUS

(71) Applicant: CANON KABUSHIKI KAISHA, Tokyo (JP)

(72) Inventor: MASAYASU TERAMURA, Osaka (JP)

(21) Appl. No.: 19/575,019

(22) Filed: Mar. 23, 2026

(30) Foreign Application Priority Data
Mar. 26, 2025 (JP) 2025-051290

(51) Int. Cl. G01M 11/02

(52) U.S. Cl. CPC G01M 11/0221

(57) ABSTRACT

A lens array evaluating method includes arranging a lens array including a plurality of lens portions between a light source unit and a light receiving unit, moving at least one of the light source unit, the light receiving unit, and the lens array in a plane perpendicular to an optical axis direction such that at least one lens portion intersects an optical path of measurement light from the light source unit, causing the light receiving unit to receive the measurement light having passed through a predetermined lens portion of the at least one lens portion at a plurality of timings in the moving, calculating a gradient at each position in a positional dependence of a light amount of the measurement light for the at least one lens portion from time dependence of the light amount, and evaluating the lens array based on information obtained in the calculating.

This application claims the benefit of Japanese Patent Application No. 2025-051290, filed Mar. 26, 2025, which is hereby incorporated by reference herein in its entirety.

### BACKGROUND

### Field of the Technology

The aspect of the embodiments is related to a method of evaluating a lens array, an apparatus for evaluating a lens array, and a method of manufacturing an optical apparatus, which are suitably used in a method of manufacturing an image forming apparatus such as a laser beam printer (LBP), a digital copier, or a multi-function printer (MFP).

### Description of the Related Art

Japanese Patent Laid-Open No. S56-635 discloses an evaluating method for evaluating optical characteristics of a lens array by calculating a modulation transfer function (MTF) of the lens array.

In the evaluating method disclosed in Japanese Patent Laid-Open No. S56-635, it is difficult to distinguish between a lens portion having a positional deviation and that having a different focal length with respect to other lens portions, among a plurality of lens portions included in the lens array.

In other words, it is difficult to compare focal lengths of the plurality of lens portions included in the lens array with each other by the evaluating method disclosed in Japanese Patent Laid-Open No. S56-635.

### SUMMARY

A method according to the aspect of the embodiments includes arranging a lens array including a plurality of lens portions between a light source unit and a light receiving unit, moving at least one of the light source unit, the light receiving unit, and the lens array in a first plane perpendicular to an optical axis direction such that at least one lens portion of the plurality of lens portions intersects an optical path of measurement light from the light source unit, causing the light receiving unit to receive the measurement light having passed through a predetermined lens portion of the at least one lens portion at a plurality of timings in the moving, calculating a gradient at each position in a positional dependence of a light amount of the measurement light for the at least one lens portion received by the light receiving unit from time dependence of the light amount, and evaluating the lens array based on information obtained in the calculating.

Features of the disclosure will become apparent from the following description of embodiments with reference to the attached drawings. The following description of embodiments is described by way of example.

### BRIEF DESCRIPTION OF THE DRAWINGS

FIG. 1A is a top view of a lens array evaluating apparatus according to a first embodiment of the disclosure.

FIG. 1B is a partial front view of the lens array evaluating apparatus according to the first embodiment.

FIG. 2A is a partial top view of the lens array evaluating apparatus according to the first embodiment, and graphs showing a change in an output from a light receiving element and a change in a gradient of the output.

FIG. 2B is a partial top view of the lens array evaluating apparatus according to the first embodiment, and graphs showing a change in an output from a light receiving element and a change in a gradient of the output.

FIG. 2C is a partial front view of a lens array, and graphs showing a change in an output from a light receiving element in the lens array evaluating apparatus according to the first embodiment and a change in a gradient of the output.

FIG. 3A is a top view of a lens array evaluating apparatus according to a second embodiment of the disclosure.

FIG. 3B is a partial front view of the lens array evaluating apparatus according to the second embodiment.

FIG. 4 is partial top views of the lens array evaluating apparatus according to the second embodiment, and graphs showing changes in outputs from first and second light receiving elements and changes in gradient of the outputs.

FIG. 5 is partial top views of the lens array evaluating apparatus according to the second embodiment, and graphs showing changes in outputs from the first and second light receiving elements and changes in gradient of the outputs.

FIG. 6 is a partial front view of a lens array, graphs showing positional dependences of gradients of outputs from the first and second light receiving elements in the lens array evaluating apparatus according to the second embodiment and a difference between the gradients.

FIG. 7A is a graph showing a positional dependence of gradients of changes in light amount of light fluxes passing through a normal lens portion and an abnormal lens portion.

FIG. 7B is a graph showing a positional dependence of a difference between the gradients of the changes in light amount of the light fluxes passing through the normal lens portion and the abnormal lens portion.

FIG. 8A is a graph showing an example of a measurement result of focus deviation of each lens portion obtained by the lens array evaluating apparatus according to the second embodiment.

FIG. 8B is a graph showing an example of a measurement result of focus deviation of each lens portion obtained by the lens array evaluating apparatus according to the second embodiment.

FIG. 8C is a graph showing an example of a measurement result of focus deviation of each lens portion obtained by the lens array evaluating apparatus according to the second embodiment.

FIG. 8D is a graph showing an example of a measurement result of focus deviation of each lens portion obtained by the lens array evaluating apparatus according to the second embodiment.

FIG. 8E is a graph showing an example of a measurement result of focus deviation of each lens portion obtained by the lens array evaluating apparatus according to the second embodiment.

FIG. 9 is a flowchart of an assembly process of an exposing unit according to the disclosure.

FIG. 10A is a partial front view of a lens array.

FIG. 10B is a partial front view of a lens array.

FIG. 10C is a partial front view of a lens array.

FIG. 10D is a partial front view of a light source.

FIG. 10E is a partial front view of an exposing unit.

FIG. 10F is a partial front view of an exposing unit.

FIG. 10G is a partial front view of an exposing unit.

### DESCRIPTION OF THE EMBODIMENTS

Hereinafter, an evaluating method and an evaluating apparatus for a lens array according to the disclosure are described in detail with reference to the accompanying drawings. Note that the drawings described below may be drawn on a scale different from the actual scale in order to facilitate understanding of the disclosure.

Further, a direction parallel to optical axes of a plurality of lens portions 1020 included in a lens array 102 (optical axis direction, direction in which a light flux 106 travels) is defined as an X direction, a direction in which the lens array 102 is scanned is defined as a Y direction, and a direction perpendicular to the X direction and the Y direction is defined as a Z direction.

### First embodiment

In recent years, an evaluation accuracy in a lens array evaluating method for evaluating optical characteristics of a lens array has been improved.

For example, a lens array evaluating method has been proposed in which an arrangement state such as a parallel deviation or an angular deviation of each lens included in a lens array is evaluated by using a light receiving unit arranged to be inclined with respect to the lens array.

However, although a positional deviation of each lens included in the lens array can be evaluated by the proposed lens array evaluating method, it is difficult to quantitatively evaluate a change in a focal length of each lens.

Further, for example, a lens array evaluating method for evaluating a modulation transfer function (MTF) of each lens included in a lens array has been proposed.

However, in the proposed lens array evaluating method, it is difficult to quantitatively evaluate a change of a focal length of each lens since a change of the MTF in which a positional deviation and the change of the focal length in each lens are combined is evaluated.

Accordingly, an object of the disclosure is to provide a lens array evaluating method and a lens array evaluating apparatus capable of quantitatively evaluating a change in focal length regardless of a positional deviation of each lens included in a lens array.

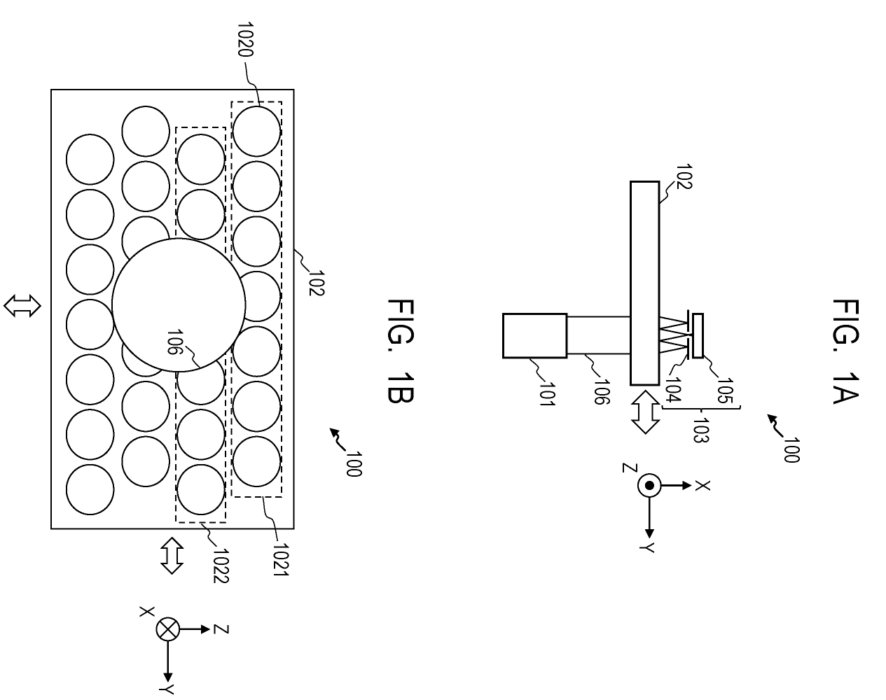

FIGS. 1A and 1B show a schematic top view and a partial schematic front view of a lens array evaluating apparatus 100 according to a first embodiment of the disclosure, respectively.

The lens array evaluating apparatus 100 according to the embodiment includes a light source 101 and a light receiving unit 103, and is configured to evaluate a focal length (focal position) of each of a plurality of lens portions 1020 included in a lens array 102.

Further, the lens array evaluating apparatus 100 according to the embodiment includes a controller (not shown) that performs each step in the evaluation.

A semiconductor laser or the like is used as the light source 101, and it is configured to emit a substantially parallel light flux 106 (measurement light).

The lens array 102 includes a plurality of lens portions 1020 arrayed in a YZ plane (first plane).

Specifically, the lens array 102 includes a first lens group 1021 formed of a plurality of lens portions 1020 arrayed on a predetermined straight line parallel to the Y direction as shown in FIG. 1B.

Further, the lens array 102 includes a second lens group 1022 formed of a plurality of lens portions 1020 which are arrayed on another straight line which is parallel to the Y direction and different from the predetermined straight line.

Hereinafter, a lens group formed of a plurality of lens portions 1020 arrayed on a predetermined straight line parallel to the Y direction may be referred to as a lens group on the predetermined straight line.

Further, the lens array evaluating apparatus 100 according to the embodiment includes a driving unit (not shown) that moves the lens array 102 in each of the Y direction and the Z direction.

Note that the driving unit may move at least one of the light source 101 and the light receiving unit 103, namely may be configured to move at least one of the light source 101, the lens array 102, and the light receiving unit 103.

The driving unit moves the lens array 102 in each of the Y direction and the Z direction, thereby a light flux 106 emitted from the light source 101 and having passed through a predetermined lens portion 1020 can be condensed in the vicinity of the light receiving unit 103 to be received by it.

The light receiving unit 103 has a stop 104 in which a circular opening is formed and through which a part of the incident light flux 106 passes, and a light receiving element 105 that receives the part of the light flux 106 having passed through the stop 104.

Specifically, the stop 104 is configured to shield the light flux 106 having passed through lens portions 1020 other than a predetermined lens portion 1020 among a plurality of lens portions 1020 included in the lens array 102.

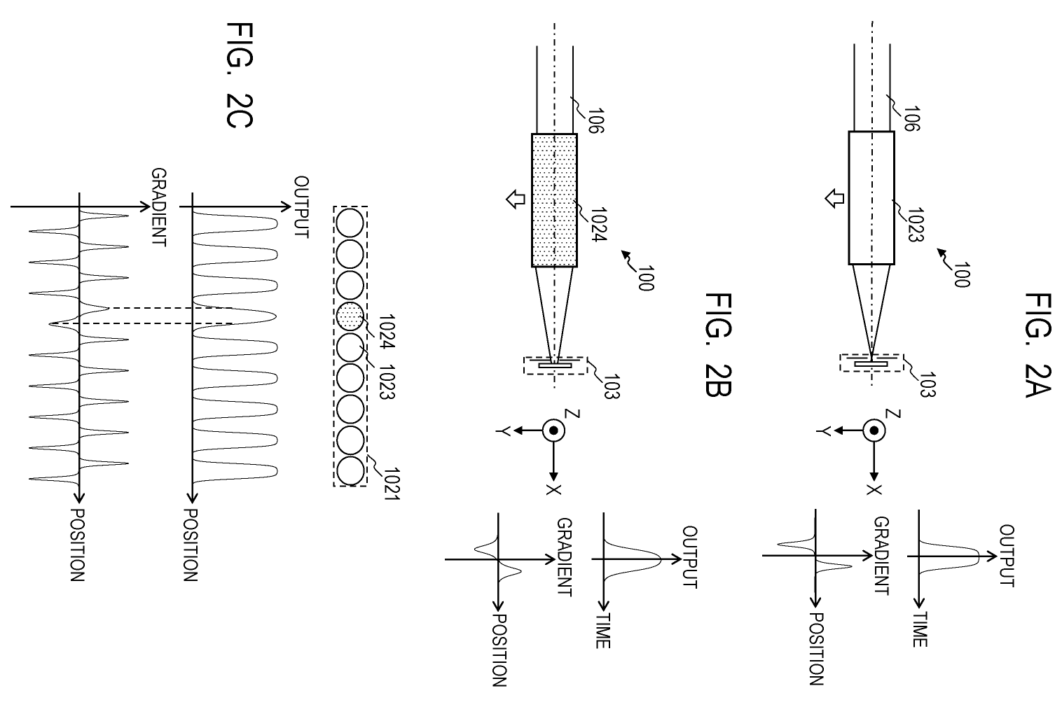

FIGS. 2A and 2B show partial schematic top views of the lens array evaluating apparatus 100 according to the embodiment.

Specifically, FIG. 2A shows a state in which the light flux 106 having passed through a predetermined lens portion 1023 is received by the light receiving unit 103, a time dependence of an output by the light reception from the light receiving element 105, and a positional dependence of a gradient of the output.

Further, FIG. 2B shows a state in which the light flux 106 having passed through another lens portion 1024 is received by the light receiving unit 103, a time dependence of an output by the light reception from the light receiving element 105, and a positional dependence of a gradient of the output.

In FIG. 2B and the following drawings, the lens portion 1024 is hatched for convenience to clearly show that a focal length is abnormal as compared with the lens portion 1023 having a normal focal length.

Specifically, the lens portion 1023 having the normal focal length means the lens portion 1023 having the focal length according to a designed value, and the lens portion 1024 having an abnormal focal length means the lens portion 1024 having the focal length different from the designed value.

Here, it is assumed that the focal length of the lens portion 1023 is normal, and the light flux 106 having passed through the lens portion 1023 is condensed in the vicinity of the stop 104 of the light receiving unit 103 as shown in FIG. 2A.

Then, when the lens array 102 is scanned in the Y direction, the output from the light receiving element 105 by receiving the light flux 106 having passed through the lens portion 1023 changes with time as shown in FIG. 2A.

On the other hand, it is assumed that the focal length of the lens portion 1024 is abnormal, and the light flux 106 having passed through the lens portion 1024 is condensed at a position away from the stop 104 of the light receiving unit 103 in the X direction as shown in FIG. 2B.

Then, when the lens array 102 is scanned in the Y direction, the output from the light receiving element 105 by receiving the light flux 106 having passed through the lens portion 1024 changes with time as shown in FIG. 2B, and specifically, becomes smaller than the change with time of the output regarding the lens portion 1023.

Hereinafter, the lens portion 1023 having the normal focal length may be simply referred to as a normal lens portion 1023, whereas the lens portion 1024 having the abnormal focal length may be simply referred to as an abnormal lens portion 1024.

Further, in one embodiment, the lens array 102 is scanned at a constant speed in the Y direction since the time dependence of the output from the light receiving element 105 is converted into a dependence of the output with respect to the position in the Y direction of the lens array 102 as described below.

In addition, the time dependence of the output from the light receiving element 105 by receiving the light flux 106 having passed through a predetermined lens portion 1020 can be converted into the dependence of the output with respect to the position in the Y direction of the predetermined lens portion 1020 by a scanning speed of the lens array 102 in the Y direction. Hereinafter, the dependence is referred to as a Y position dependence of the predetermined lens portion 1020 of the output.

That is, it is possible to specify the position in the Y direction of the predetermined lens portion 1020 corresponding to each output from the light receiving element 105.

In the lens array evaluating apparatus 100 according to the embodiment, a difference between the outputs adjacent to each other is calculated in the Y position dependence of the lens array 102 of the output from the light receiving element 105 obtained as described above.

Then, Y position dependences of the lens portions 1023 and 1024 of a gradient of the output can be obtained by dividing the calculated difference by a pitch interval as shown in FIGS. 2A and 2B.

Although the difference between the outputs adjacent to each other is calculated, the embodiment is not limited thereto, and an average value of a plurality of outputs included in a predetermined range may be calculated first, and then a difference between the average values of the outputs adjacent to each other may be calculated in order to reduce the influence of noise.

Note that the lens array evaluating apparatus 100 according to the embodiment is not limited to the above, and a differential calculation may be performed on an obtained function after fitting the Y position dependence of the lens array 102 of the output from the light receiving element 105 with a predetermined function.

In addition, when it is considered that the calculation of the difference to be divided by the pitch interval is included in the differential calculation as described above, the Y position dependence of the gradient of the output can be obtained by performing the differential calculation on the Y position dependence of the output from the light receiving element 105 in the lens array evaluating apparatus 100 according to the embodiment.

FIG. 2C shows a Y position dependence of each of the output from the light receiving element 105 and the gradient of the output obtained in the lens array evaluating apparatus 100 according to the embodiment.

Specifically, FIG. 2C shows a Y position dependence of each of the output from the light receiving element 105 and the gradient of the output by the reception of the light flux 106 having passed through each lens portion of the first lens group 1021 included in the lens array 102 when the lens array 102 is scanned in the Y direction.

As shown in FIG. 2C, for the first lens group 1021, the output from the light receiving element 105 corresponding to the lens portion 1024 and the gradient of the output are smaller than the outputs and the gradients of other lens portions 1020 including the lens portion 1023, respectively.

That is, it can be seen that a focal length of the lens portion 1023 is normal, whereas the focal length of the lens portion 1024 is abnormal in the first lens group 1021 from the output from the light receiving element 105 and the gradient of the output.

As described above, it is possible to determine whether the focal length of each of the plurality of lens portions 1020 is normal or abnormal by comparing the outputs from the light receiving element 105 of the plurality of lens portions 1020 and the gradients of the outputs with each other in the lens array evaluating apparatus 100 according to the embodiment.

In addition, a spot diameter of the light flux 106 having passed through a predetermined lens portion 1020 can be calculated in the lens array evaluating apparatus 100 according to the embodiment as follows.

Specifically, the difference between the outputs adjacent to each other in the Y position dependence of the output from the light receiving element 105 by receiving the light flux 106 having passed through the predetermined lens portion 1020 is calculated.

Next, a line spread function (LSF) is calculated from the Y position dependence of the gradient of the output obtained by dividing the calculated difference by the pitch interval.

Then, the spot diameter can be calculated from a width between values of 1/e² of the maximum value in the calculated LSF.

In addition, a relationship between a change in the spot diameter and a deviation of the focal length may be obtained in advance, and the deviation of the focal length corresponding to the spot diameter calculated as described above in a predetermined lens portion 1020 can be obtained by referring to the relationship.

Since an influence of optical aberration is added to the spot diameter calculated as described above as compared with a peak of the gradient of the output from the light receiving element 105, in one embodiment, the spot diameter is used as an index for evaluating the focal length of each of the plurality of lens portions 1020 included in the lens array 102.

Further, it is also possible to calculate a modulation transfer function (MTF) of the predetermined lens portion 1020 by performing a Fourier transform on the LSF calculated for the predetermined lens portion 1020 as described above.

Then, a relationship between a change in the MTF and the deviation of the focal length may be obtained in advance, and the deviation of the focal length corresponding to the MTF calculated as described above in a predetermined lens portion 1020 can be obtained by referring to the relationship.

Since a spatial frequency can be analyzed in the MTF calculated as described above, the influence of optical aberration can be considered in more detail. Therefore, in one embodiment, the MTF is used as an index for evaluating the focal length of each of the plurality of lens portions 1020 included in the lens array 102.

As described above, a moving step of moving the lens array 102 in the YZ plane is performed by the driving unit (not shown) such that at least one lens portion 1020 of the lens array 102 intersects an optical path of the light flux 106 in the lens array evaluating apparatus 100 according to the embodiment.

Further, a light receiving step of causing the light receiving unit 103 to receive only the light flux 106 having passed through a predetermined lens portion 1020 of the at least one lens portion 1020 at each timing of the moving step is performed.

Then, a calculating step of performing a difference calculation or a differential calculation on time dependence of a light amount of the light flux 106 received by the light receiving unit 103 in the light receiving step is performed.

In this way, it is possible to quantitatively evaluate the change in the focal length of each of the plurality of lens portions 1020 included in the lens array 102 based on the output from the light receiving element 105.

In other words, it is possible to provide the lens array evaluating apparatus 100 according to the embodiment capable of quantitatively evaluating the change in the focal length of each of the plurality of lens portions 1020 even when the lens portion 1020 in which a positional deviation occurs is included.

In the above description, the refractive index distribution type lens array 102 is evaluated in the lens array evaluating apparatus 100 according to the embodiment, but the embodiment is not limited thereto.

That is, the lens array evaluating apparatus 100 according to the embodiment can also evaluate a lens array that refracts or reflects incident light, such as a lens array on which an optical surface or a fine structure is formed.

### Second embodiment

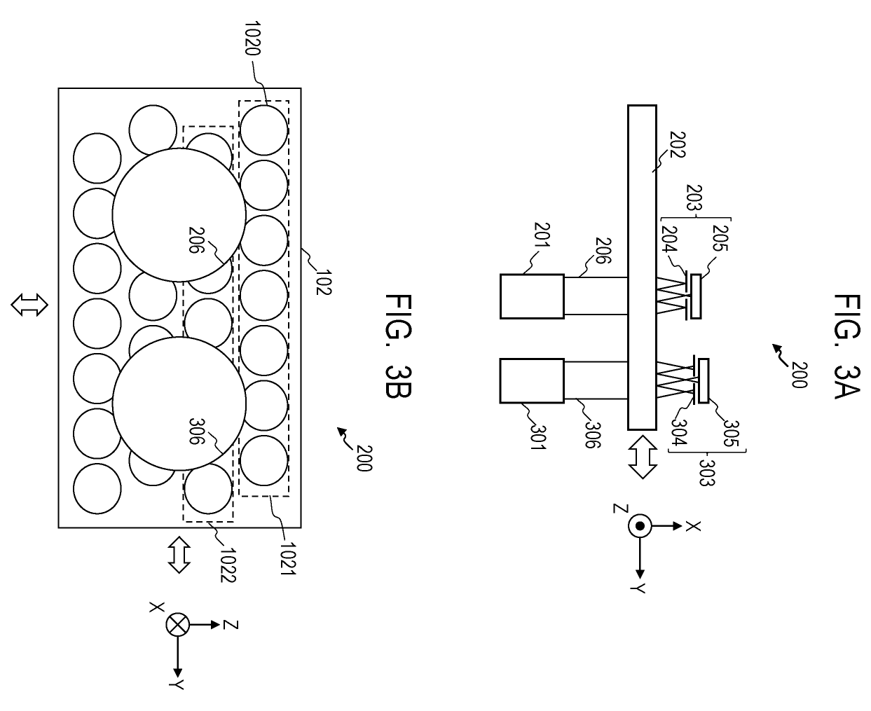

FIGS. 3A and 3B show a schematic top view and a partial schematic front view of a lens array evaluating apparatus 200 according to a second embodiment of the disclosure, respectively.

The lens array evaluating apparatus 200 according to the embodiment includes first and second light sources 201 and 301, and first and second light receiving units 203 and 303, and is configured to evaluate a focal length of each of a plurality of lens portions 1020 included in a lens array 102.

Further, the lens array evaluating apparatus 200 according to the embodiment includes a controller (not shown) that performs each step in the evaluation.

In the lens array evaluating apparatus 200 according to the embodiment, the first and second light sources 201 and 301 may be collectively referred to as a light source unit, and the first and second light receiving units 203 and 303 may be collectively referred to as a light receiving unit.

A semiconductor laser or the like is used as each of the first and second light sources 201 and 301, and they are configured to emit substantially parallel first and second light fluxes 206 and 306 (first measurement light and second measurement light), respectively.

The lens array 102 has a plurality of lens groups, and specifically, has a first lens group 1021 formed of a plurality of lens portions 1020 arrayed on a predetermined straight line parallel to the Y direction as shown in FIG. 3B.

Further, the lens array 102 has a second lens group 1022 formed of a plurality of lens portions 1020 which are arrayed on another straight line which is parallel to the Y direction and different from the predetermined straight line.

In addition, the lens array evaluating apparatus 200 according to the embodiment includes a driving unit (not shown) that moves the lens array 102 in each of the Y direction and the Z direction.

The driving unit moves the lens array 102 in each of the Y direction and the Z direction, thereby the first light flux 206 emitted from the first light source 201 and having passed through a predetermined lens portion 1020 can be condensed in the vicinity of the first light receiving unit 203 to be received by it.

Further, by moving the lens array 102 in each of the Y direction and the Z direction, the second light flux 306 emitted from the second light source 301 and having passed through the predetermined lens portion 1020 can be condensed in the vicinity of the second light receiving unit 303 to be received by it.

The first light receiving unit 203 has a first stop 204 in which a circular opening is formed and through which a part of the incident first light flux 206 passes, and a first light receiving element 205 that receives the part of the first light flux 206 having passed through the first stop 204.

Further, the second light receiving unit 303 has a second stop 304 in which a circular opening is formed and through which a part of the incident second light flux 306 passes, and a second light receiving element 305 that receives the part of the second light flux 306 having passed through the second stop 304.

In the lens array evaluating apparatus 200 according to the embodiment, the distance in the X direction between the lens array 102 and the first stop 204 is different from that between the lens array 102 and the second stop 304.

Specifically, the distance in the X direction between the lens array 102 and the first stop 204 is set such that the first light flux 206 having passed through the lens portion 1020 having a normal focal length is condensed in the vicinity of the first stop 204.

On the other hand, the distance in the X direction between the lens array 102 and the second stop 304 is set such that the second light flux 306 having passed through the lens portion 1020 having an abnormal focal length is condensed in the vicinity of the second stop 304.

The first and second light receiving units 203 and 303 are arranged on the same side with respect to a YZ plane including a movement locus of the lens array 102.

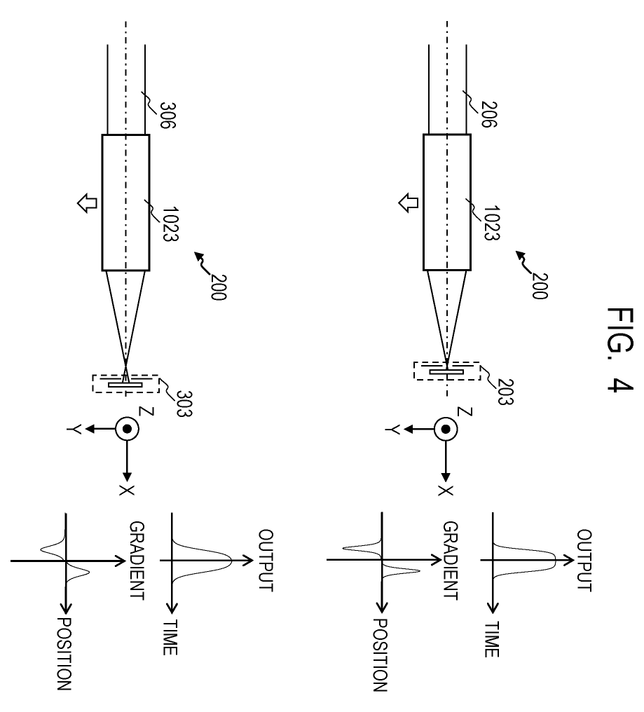

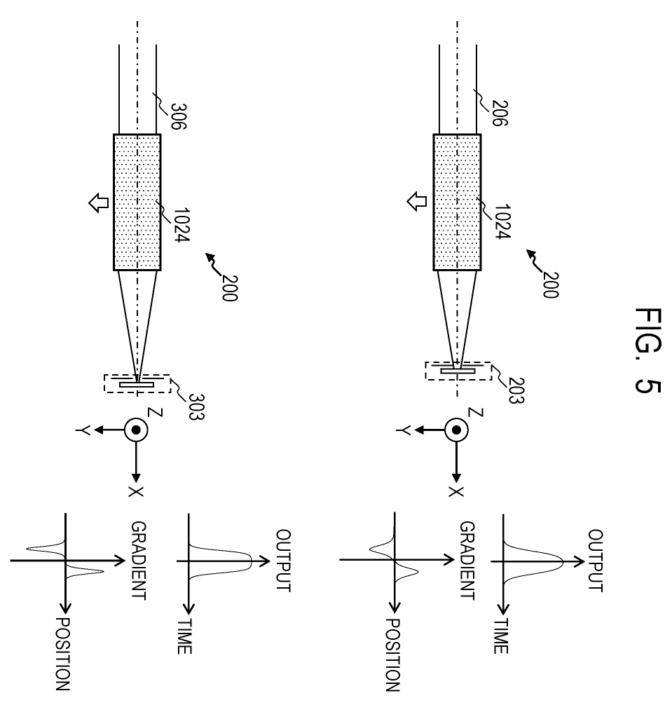

FIGS. 4 and 5 show partial schematic top views of the lens array evaluating apparatus 200 according to the embodiment.

Specifically, FIG. 4 shows a state in which the first and second light fluxes 206 and 306 having passed through a predetermined lens portion 1023 are received by the first and second light receiving units 203 and 303, respectively.

Further, FIG. 4 shows time dependences of outputs (first and second light amounts) by the light reception from the first and second light receiving elements 205 and 305 and positional dependences of gradients (first and second gradients) of the outputs.

In addition, FIG. 5 shows a state in which the first and second light fluxes 206 and 306 having passed through another lens portion 1024 are received by the first and second light receiving units 203 and 303, respectively.

Further, FIG. 5 shows time dependences of outputs by the light reception from the first and second light receiving elements 205 and 305 and positional dependences of gradients of the outputs.

First, it is assumed that the focal length of the lens portion 1023 is normal, and the first light flux 206 having passed through the lens portion 1023 is condensed in the vicinity of the first stop 204 of the first light receiving unit 203 as shown in FIG. 4.

Then, when the lens array 102 is scanned in the Y direction, the output from the first light receiving element 205 by receiving the first light flux 206 having passed through the lens portion 1023 changes with time as shown in FIG. 4.

On the other hand, the second light flux 306 having passed through the lens portion 1023 is condensed at a position away from the second stop 304 of the second light receiving unit 303 in the X direction as shown in FIG. 4.

Then, when the lens array 102 is scanned in the Y direction, the output from the second light receiving element 305 by receiving the second light flux 306 having passed through the lens portion 1023 changes with time as shown in FIG. 4.

Specifically, the output from the second light receiving element 305 by receiving the second light flux 306 having passed through the lens portion 1023 is smaller than the output from the first light receiving element 205 by receiving the first light flux 206 having passed through the lens portion 1023.

Further, it is assumed that the focal length of the lens portion 1024 is abnormal, and the first light flux 206 having passed through the lens portion 1024 is condensed at a position away from the first stop 204 of the first light receiving unit 203 in the X direction as shown in FIG. 5.

Then, when the lens array 102 is scanned in the Y direction, the output from the first light receiving element 205 by receiving the first light flux 206 having passed through the lens portion 1024 changes with time as shown in FIG. 5.

Specifically, the output from the first light receiving element 205 by receiving the first light flux 206 having passed through the lens portion 1024 is smaller than the output from the first light receiving element 205 by receiving the first light flux 206 having passed through the lens portion 1023.

On the other hand, the second light flux 306 having passed through the lens portion 1024 is condensed in the vicinity of the second stop 304 of the second light receiving unit 303 as shown in FIG. 5.

Then, when the lens array 102 is scanned in the Y direction, the output from the second light receiving element 305 by receiving the second light flux 306 having passed through the lens portion 1024 changes with time as shown in FIG. 5.

Specifically, the output from the second light receiving element 305 by receiving the second light flux 306 having passed through the lens portion 1024 is larger than the output from the first light receiving element 205 by receiving the first light flux 206 having passed through the lens portion 1024.

Further, the output from the second light receiving element 305 by receiving the second light flux 306 having passed through the lens portion 1024 is larger than the output from the second light receiving element 305 by receiving the second light flux 306 having passed through the lens portion 1023.

Further, the time dependence of the output from the first light receiving element 205 by receiving the first light flux 206 having passed through a predetermined lens portion 1020 can be converted into a Y position dependence of the predetermined lens portion 1020 of the output by a scanning speed in the Y direction of the lens array 102.

That is, it is possible to specify a position in the Y direction of the predetermined lens portion 1020 corresponding to each output from the first light receiving element 205.

Similarly, the time dependence of the output from the second light receiving element 305 by receiving the second light flux 306 having passed through the predetermined lens portion 1020 can be converted into the Y position dependence of the predetermined lens portion 1020 of the output by the scanning speed in the Y direction of the lens array 102.

That is, it is possible to specify the position in the Y direction of the predetermined lens portion 1020 corresponding to each output from the second light receiving element 305.

In the lens array evaluating apparatus 200 according to the present embodiment, a difference between the outputs adjacent to each other is calculated in each of the Y position dependences of the lens array 102 of the outputs from the first and second light receiving elements 205 and 305 obtained as described above.

Then, a Y position dependence of the lens portion 1023 of a gradient of the output from each of the first and second light receiving elements 205 and 305 can be obtained by dividing the calculated difference by a pitch interval as shown in FIG. 4.

Similarly, a Y position dependence of the lens portion 1024 of the gradient of the output from each of the first and second light receiving elements 205 and 305 can be obtained as shown in FIG. 5.

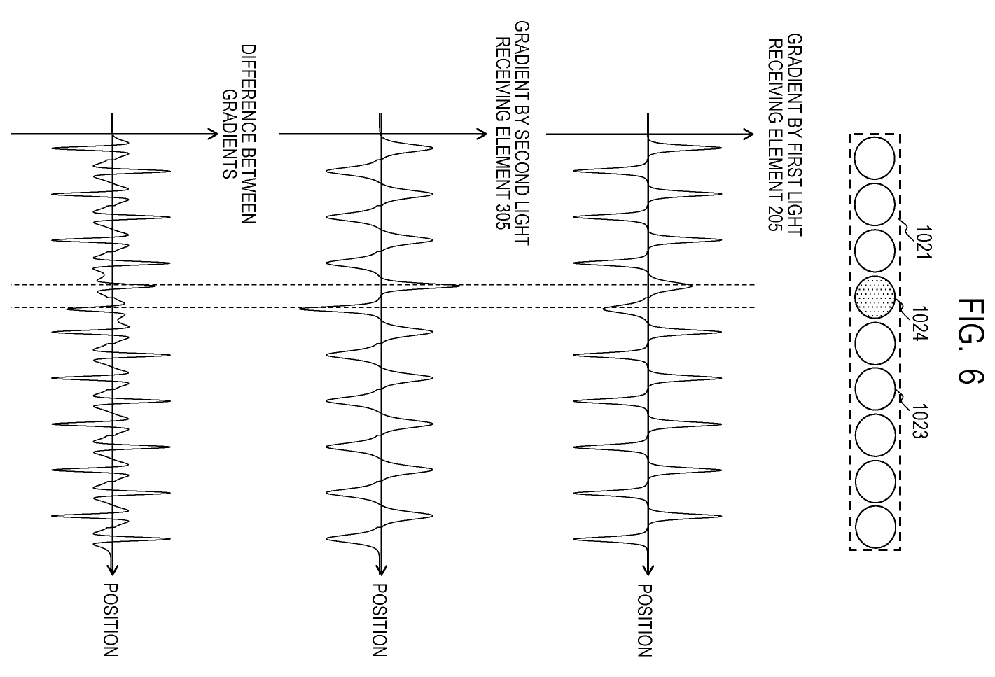

FIG. 6 shows a Y position dependence of each of the gradients of the outputs from the first and second light receiving elements 205 and 305 and a difference between the gradients, which are obtained by the lens array evaluating apparatus 200 according to the embodiment.

Specifically, FIG. 6 shows the Y position dependence of the gradient of the output from the first light receiving element 205 by the reception of the first light flux 206 having passed through each lens portion of the first lens group 1021 included in the lens array 102 when the lens array 102 is scanned in the Y direction.

Further, FIG. 6 shows the Y position dependence of the gradient of the output from the second light receiving element 305 by the reception of the second light flux 306 having passed through each lens portion of the first lens group 1021 included in the lens array 102 when the lens array 102 is scanned in the Y direction.

Furthermore, FIG. 6 shows the Y position dependence of the difference between the gradients of the outputs from the first and second light receiving elements 205 and 305.

As shown in FIG. 6, for the first lens group 1021, the gradient of the output from the first light receiving element 205 corresponding to the lens portion 1024 is smaller than the gradients of the outputs of other lens portions 1020 including the lens portion 1023.

On the other hand, the gradient of the output from the second light receiving element 305 corresponding to the lens portion 1024 is larger than the gradients of the outputs of other lens portions 1020 including the lens portion 1023.

That is, the focal length of the lens portion 1023 is normal, whereas the focal length of the lens portion 1024 is abnormal in the first lens group 1021.

In addition, as shown in FIG. 6, it is possible to extract the lens portion 1024 having an abnormal focal length included in the lens array 102 by calculating the difference between the gradients of the outputs from the first and second light receiving elements 205 and 305.

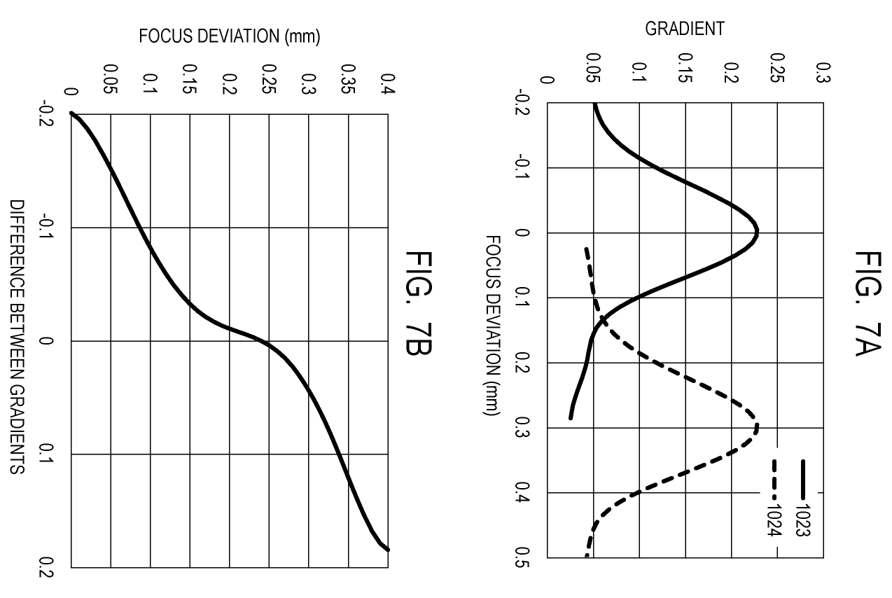

FIG. 7A shows a position dependence in the X direction of a gradient of a light amount change of a predetermined light flux having passed through each of the normal lens portion 1023 and the abnormal lens portion 1024.

As for the horizontal axis in FIG. 7A, the position in the X direction where the gradient of the light amount change of the predetermined light flux having passed through the normal lens portion 1023 becomes maximum is set as 0 mm.

For example, when there is a predetermined difference between a refractive index of the normal lens portion 1023 and that of the abnormal lens portion 1024, a difference occurs between respective focal lengths, namely a focus deviation occurs.

At this time, as shown in FIG. 7A, the gradient of the light amount change of the predetermined light flux having passed through the normal lens portion 1023 becomes maximum at the position of 0 mm, whereas that of the predetermined light flux having passed through the abnormal lens portion 1024 becomes maximum at a position of 0.3 mm.

That is, a light amount distribution of the predetermined light flux having passed through the normal lens portion 1023 and that of the predetermined light flux having passed through the abnormal lens portion 1024 are shifted from each other in the X direction.

Then, from FIG. 7A, it is possible to obtain a positional dependence in the X direction of a difference between the gradients of the light amount changes of the predetermined light fluxes having passed through the normal lens portion 1023 and the abnormal lens portion 1024, respectively.

That is, the focal length of a predetermined lens portion 1020, in other words, the focus deviation of the predetermined lens portion 1020 with respect to the normal lens portion 1023 can be calculated from the difference between the gradients of the normal lens portion 1023 and the predetermined lens portion 1020 based on the obtained positional dependence.

FIG. 7B shows a relationship between the difference between the gradients of the outputs from the first and second light receiving elements 205 and 305 obtained in the lens array evaluating apparatus 200 according to the embodiment, and the focus deviation.

Specifically, FIG. 7B shows the relationship between the difference between the gradients of the outputs from the first and second light receiving elements 205 and 305 by receiving the first and second light fluxes 206 and 306 each of which has passed through the predetermined lens portion 1020, and the focus deviation.

As shown in FIG. 7B, the focus deviation of the predetermined lens portion 1020 can be calculated from the difference between the gradients of the outputs from the first and second light receiving elements 205 and 305 by receiving the first and second light fluxes 206 and 306 having passed through the predetermined lens portion 1020.

In other words, the difference between the gradients of the outputs from the first and second light receiving elements 205 and 305 is different between the case where the first and second light fluxes 206 and 306 pass through the normal lens portion 1023 and the case where they pass through the abnormal lens portion 1024.

The relationship shown in FIGS. 7A and 7B can be obtained, for example, by performing an optical simulation for the lens array evaluating apparatus 200 according to the embodiment or by performing a measurement in advance in the lens array evaluating apparatus 200 according to the embodiment.

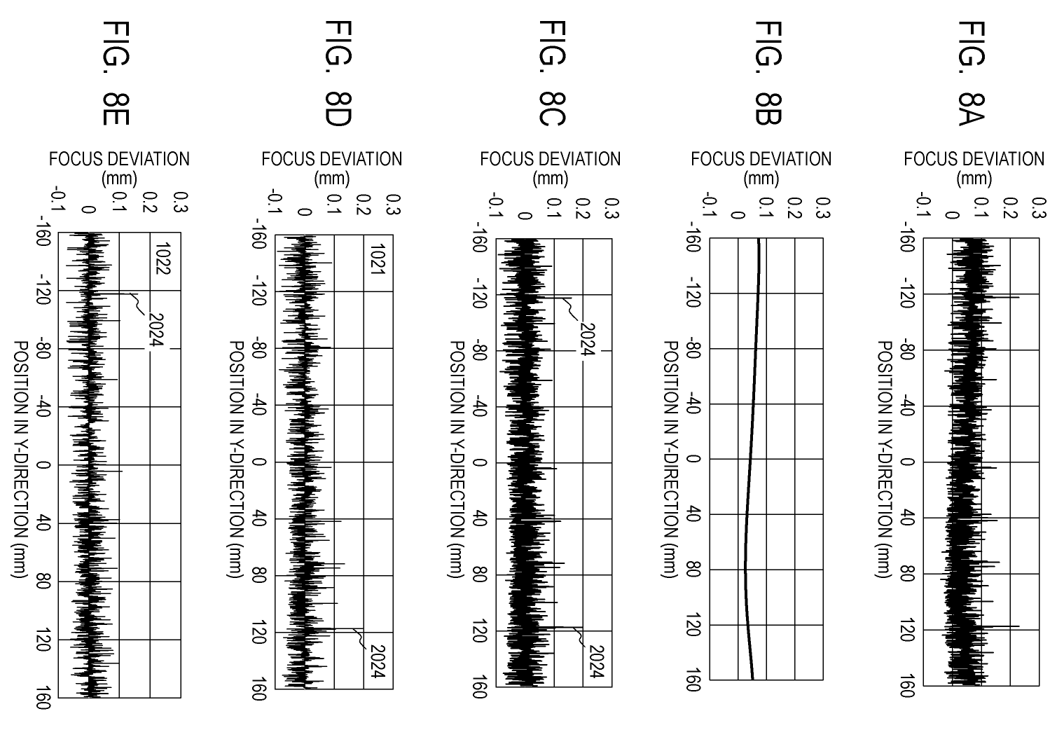

FIG. 8A shows an example of a measurement result of the focus deviation of each of a plurality of lens portions 1020 included in the lens array 102 obtained in the lens array evaluating apparatus 200 according to the embodiment.

Specifically, FIG. 8A shows the focus deviation at each position in the Y direction obtained when scanning is performed in the Y direction in a state in which the lens array 102 is positioned in the Z direction such that the first and second light fluxes 206 and 306 are incident on a predetermined lens group, in which the focus deviation is superimposed for each lens group.

As described above with reference to FIG. 7B, the focus deviation shown in FIG. 8A can be calculated from the difference between the gradients of the outputs from the first and second light receiving elements 205 and 305 by receiving the first and second light fluxes 206 and 306.

Here, the focus deviation at each position in the Y direction shown in FIG. 8A includes components due to a curvature, a positional deviation or the like of the lens array 102 in addition to a change in optical characteristics such as a refractive index of each of the plurality of lens portions 1020 included in the lens array 102.

Therefore, the focus deviation at each position in the Y direction shown in FIG. 8A is fitted using a polynomial function in the lens array evaluating apparatus 200 according to the embodiment.

Thereby, it is possible to extract an averaged focus deviation associated with the components as shown in FIG. 8B.

Then, the focus deviation at each position in the Y direction shown in FIG. 8A is corrected by calculating a difference with respect to the focus deviation at each position in the Y direction shown in FIG. 8B in the lens array evaluating apparatus 200 according to the embodiment.

Thereby, it is possible to obtain the focus deviation at each position in the Y direction due to a change in the optical characteristics such as the refractive index of each of the plurality of lens portions 1020 included in the lens array 102 as shown in FIG. 8C.

That is, it is possible to evaluate the focus deviation of each of the plurality of lens portions 1020 included in the lens array 102 in a good accuracy by removing the components of the focus deviation due to the curvature, the positional deviation or the like of the lens array 102 in the lens array evaluating apparatus 200 according to the embodiment.

Thereby, it is possible to specify a position of the abnormal lens portion 1024 among the plurality of lens portions 1020 included in the lens array 102.

FIGS. 8D and 8E show a focus deviation at each position in the Y direction for the plurality of lens portions 1020 included in a first lens group 1021 and a second lens group 1022, respectively.

The focus deviation at each position in the Y direction shown in FIGS. 8D and 8E can be extracted from the focus deviation at each position in the Y direction for each of the plurality of lens portions 1020 included in the lens array 102 shown in FIG. 8C.

As shown in FIGS. 8D and 8E, it can be evaluated that the abnormal lens portion 1024 is arranged at a position in the Y direction where the focus deviation is large in each of the first lens group 1021 and the second lens group 1022.

In addition, spot diameters of the first and second light fluxes 206 and 306 having passed through the predetermined lens portion 1020 can be calculated as follows in the lens array evaluating apparatus 200 according to the embodiment.

Specifically, a difference between the outputs adjacent to each other is calculated in each of the Y position dependences of the outputs from the first and second light receiving elements 205 and 305 by receiving the first and second light fluxes 206 and 306 having passed through the predetermined lens portion 1020.

Next, a line spread function (LSF) is calculated from a Y position dependence of the gradient of the output obtained by dividing the calculated difference by a pitch interval.

Then, the spot diameter can be calculated from a width between values of 1/e² of the maximum value in the calculated LSF.

Further, a relationship between a change in the spot diameter and a deviation of a focal length may be obtained in advance, and the deviation of the focal length corresponding to the spot diameter calculated as described above in the predetermined lens portion 1020 can be obtained by referring to the relationship.

The spot diameter calculated as described above includes influences of optical aberrations than a peak of the gradient of the output from each of the first and second light receiving elements 205 and 305.

Therefore, in one embodiment, the spot diameter calculated as described above is used as an index for evaluating the focal length of each of the plurality of lens portions 1020 included in the lens array 102.

Further, it is possible to calculate a modulation transfer function (MTF) of the predetermined lens portion 1020 by performing a Fourier transform on the LSF calculated for the predetermined lens portion 1020 as described above.

In addition, a relationship between a change in the MTF and the deviation of the focal length may be obtained in advance, and the deviation of the focal length corresponding to the MTF calculated as described above in the predetermined lens portion 1020 can be obtained by referring to the relationship.

Since a spatial frequency can be analyzed by the MTF calculated as described above, the influences of optical aberrations can be considered in more detail. Therefore, in one embodiment, the MTF is used as an index for evaluating the focal length of each of the plurality of lens portions 1020 included in the lens array 102.

As described above, in the lens array evaluating apparatus 200 according to the embodiment, the moving step of moving the lens array 102 in the YZ plane is performed such that at least one lens portion 1020 of the lens array 102 intersects optical paths of the first and second light fluxes 206 and 306.

Further, a light receiving step of receiving only the first and second light fluxes 206 and 306 having passed through a predetermined lens portion 1020 of the at least one lens portion 1020 by the first and second light receiving units 203 and 303 at each timing of the moving step is performed.

Then, a calculating step of performing a difference calculation or a differential calculation on time dependences of light amounts of the first and second light fluxes 206 and 306 received by the first and second light receiving units 203 and 303 in the light receiving step is performed.

In this way, it is possible to quantitatively evaluate a change in the focal length of each of the plurality of lens portions 1020 included in the lens array 102 based on the outputs from the first and second light receiving elements 205 and 305.

According to the disclosure, it is possible to provide a lens array evaluating method capable of comparing focal lengths of respective lens portions with each other.

### Method of manufacturing an exposing unit

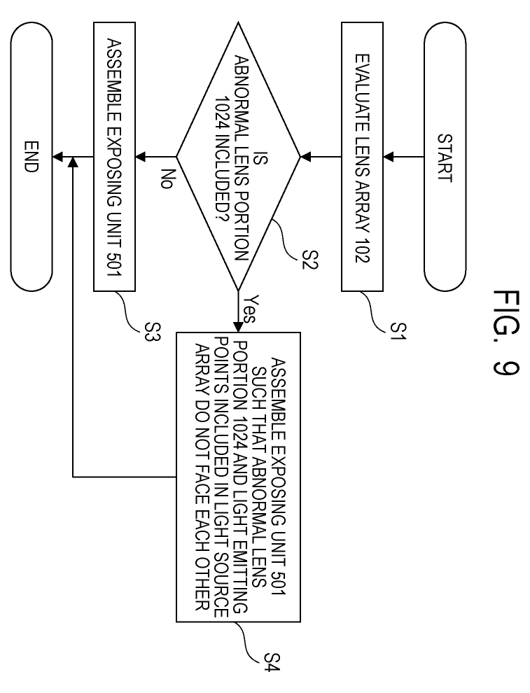

FIG. 9 shows a flowchart of an assembly process of an exposing unit 501 (optical apparatus) including an evaluating step of a lens array 102 by the lens array evaluating apparatus according to the first or second embodiment.

As shown in FIG. 9, when the assembly process of the exposing unit 501 is started, first, an evaluating step (first step) of evaluating the lens array 102 by using the lens array evaluating apparatus according to the first or second embodiment is performed (Step S1).

Then, it is determined whether an abnormal lens portion 1024 is included in the lens array 102 based on the evaluating step in Step S1 (Step S2, determining step).

When it is determined that the abnormal lens portion 1024 is not included in the lens array 102 (No in Step S2), a step (second step) of assembling the exposing unit 501 by using the lens array 102 and a light source array corresponding to the lens array 102 is performed (Step S3). Then, the process is ended.

On the other hand, when it is determined that the abnormal lens portion 1024 is included in the lens array 102 (Yes in Step S2), the process proceeds to Step S4, and then is ended.

Specifically, in Step S4, the lens array 102 and the light source array are aligned with each other such that the abnormal lens portion 1024 and light emitting points included in the light source array corresponding to the lens array 102 do not face each other to assemble the exposing unit 501.

More specifically, in Step S4, the lens array 102 is arranged such that the abnormal lens portion 1024 and the light emitting points included in the light source array do not face each other by rotating the lens array 102 by 180° around the X direction or the Y direction, for example.

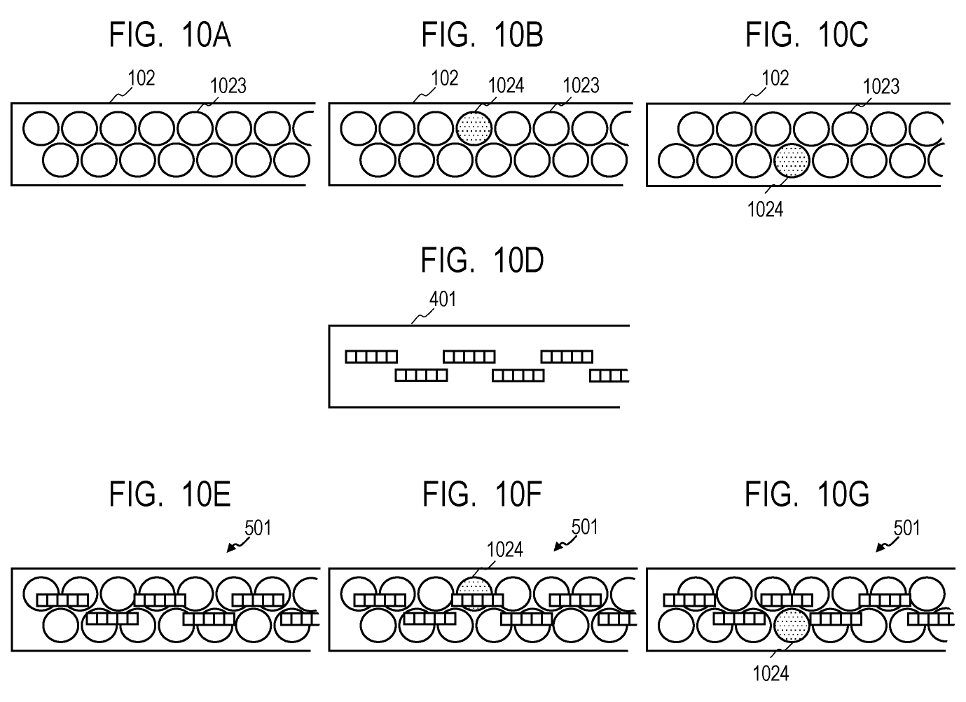

FIG. 10A shows a partial front view of the lens array 102 that does not include the abnormal lens portion 1024.

FIGS. 10B and 10C show front views of the lens array 102 including the abnormal lens portion 1024 in an upper stage and the lens array 102 including the abnormal lens portion 1024 in a lower stage, respectively.

FIG. 10D shows a front view of a light source array 401 corresponding to the lens array 102, which is used to assemble the exposing unit 501.

FIGS. 10E, 10F, and 10G, show front views of the exposing unit 501 assembled by using the lens array 102 shown in FIGS. 10A, 10B, and 10C, and the light source array 401 shown in FIG. 10D, respectively.

The lens array 102 shown in each of FIGS. 10A to 10C and 10E to 10G is constituted by lens groups of two stages of an upper stage lens group and a lower stage lens group in the Z direction.

Further, in the light source array 401 shown in FIG. 10D, a plurality of light emitting point groups each having five light emitting points arrayed in the Y direction are arranged in a staggered manner between the upper stage and the lower stage in the Z direction, namely in the YZ plane.

For example, when the exposing unit 501 is assembled by using the lens array 102 shown in FIG. 10A in accordance with the flowchart shown in FIG. 9, it is determined that an abnormal lens portion 1024 is not included in the lens array 102 in Step S2.

Then, as shown in FIG. 10E, the exposing unit 501 is assembled by using the lens array 102 and the light source array 401 in Step S3.

Further, when the exposing unit 501 is assembled by using the lens array 102 shown in FIG. 10B in accordance with the flowchart shown in FIG. 9, it is determined that an abnormal lens portion 1024 is included in the lens array 102 in Step S2.

At this time, when the exposing unit 501 is assembled by using the lens array 102 of FIG. 10B and the light source array 401 of FIG. 10D, the abnormal lens portion 1024 included in the lens array 102 and the light emitting points in the light source array 401 face each other as shown in FIG. 10F.

When the exposing unit 501 is assembled by using the lens array 102 and the light source array 401, an influence of the focus deviation of the abnormal lens portion 1024 largely appears, if the abnormal lens portion 1024 and the light emitting points included in the light source array 401 are close to each other.

Specifically, a local defect occurs in an image formed on a surface of a photosensitive drum by the exposing unit 501 in an image forming apparatus.

Therefore, in the embodiment, when it is determined that an abnormal lens portion 1024 is included in the lens array 102 in Step S2, the lens array 102 is arranged such that the abnormal lens portion 1024 and the light emitting points included in the light source array 401 do not face each other in Step S4.

That is, the lens array 102 is rotated by 180° around a straight line which passes through a center of the lens array 102 and is parallel to the Y direction as shown in FIG. 10C.

Then, when the exposing unit 501 is assembled by using the lens array 102 shown in FIG. 10C and the light source array 401 shown in FIG. 10D, the abnormal lens portion 1024 included in the lens array 102 and the light emitting points in the light source array 401 do not face each other as shown in FIG. 10G.

Thereby, when the exposing unit 501 is assembled by using the lens array 102 and the light source array 401, the abnormal lens portion 1024 and the light emitting points included in the light source array 401 are away from each other, so that it is possible to reduce the influence of the focus deviation of the abnormal lens portion 1024.

As described above, in the method of manufacturing the exposing unit 501 according to the embodiment, the exposing unit 501 is assembled such that the abnormal lens portion 1024 included in the lens array 102 and the light emitting points included in the light source array 401 do not face each other.

Thereby, it is possible to assemble the exposing unit 501 in which the influence of the focus deviation of the abnormal lens portion 1024 is reduced even when the lens array 102 including the abnormal lens portion 1024 is used.

In addition, it is possible to manufacture an image forming apparatus which can suppress a deterioration of an image quality of an image formed on the photosensitive body by aligning the exposing unit 501 assembled as described above and the developing unit which develops an electrostatic latent image formed on the surface of the photosensitive body by the exposing unit 501 as a toner image with each other.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

What is claimed is:

1. A method, comprising:
arranging a lens array including a plurality of lens portions between a light source unit and a light receiving unit;
moving at least one of the light source unit, the light receiving unit, and the lens array in a first plane perpendicular to an optical axis direction such that at least one lens portion of the plurality of lens portions intersects an optical path of measurement light from the light source unit;
causing the light receiving unit to receive the measurement light having passed through a predetermined lens portion of the at least one lens portion at a plurality of timings in the moving;
calculating a gradient at each position in a positional dependence of a light amount of the measurement light for the at least one lens portion received by the light receiving unit from time dependence of the light amount; and
evaluating the lens array based on information obtained in the calculating.

2. The method according to claim 1, wherein the calculating includes calculating a line spread function from the positional dependence of the light amount.

3. The method according to claim 2, wherein the calculating includes calculating a modulation transfer function from the line spread function.

4. The method according to claim 1, wherein the calculating includes calculating the positional dependence of the light amount for the at least one lens portion from the time dependence of the light amount based on a speed of the moving in the moving.

5. The method according to claim 1, wherein the calculating includes calculating a focal position at each position for the at least one lens portion from at least one of the gradient at each position in the positional dependence of the light amount for the at least one lens portion calculated from the time dependence of the light amount, a line spread function of the positional dependence of the light amount, and a modulation transfer function of the positional dependence of the light amount.

6. The method according to claim 5, wherein the evaluating includes determining whether an abnormal lens portion is included in the at least one lens portion based on the calculated focal position of each of the at least one lens portion.

7. The method according to claim 1,
wherein the light source unit includes first and second light sources configured to emit first and second measurement lights, respectively,
wherein the light receiving unit includes first and second light receiving units configured to receive the first and second measurement lights, respectively,
wherein a distance between the first light receiving unit and the lens array on an optical path of the first measurement light and a distance between the second light receiving unit and the lens array on an optical path of the second measurement light are different from each other,
wherein the moving includes moving at least one of the light source unit, the light receiving unit, and the lens array in the first plane such that the at least one lens portion intersects the optical paths of the first and second measurement lights from the first and second light sources,
wherein the causing includes causing the first light receiving unit to receive the first measurement light having passed through the predetermined lens portion at a plurality of timings when the at least one lens portion intersects the optical path of the first measurement light, and causing the second light receiving unit to receive the second measurement light having passed through the predetermined lens portion at a plurality of timings when the at least one lens portion intersects the optical path of the second measurement light, and
wherein the calculating includes:
calculating first and second gradients at each position in positional dependences of first and second light amounts of the first and second measurement lights for the at least one lens portion received by the first and second light receiving units in the causing from time dependences of the first and second light amounts, respectively;
calculating a difference between the calculated first and second gradients at each position for the at least one lens portion; and
calculating a focal position at each position for the at least one lens portion from the calculated difference at each position for the at least one lens portion.

8. The method according to claim 7, wherein the calculating includes correcting the calculated focal position at each position for the at least one lens portion based on positional deviation of the at least one lens portion.

9. A method of manufacturing an optical apparatus, comprising:
evaluating the lens array by the evaluating method according to claim 1; and
arranging the lens array evaluated in the evaluating in a housing.

10. The method according to claim 9, wherein the evaluating includes specifying an abnormal lens portion among the at least one lens portion based on an optical characteristic of the lens array.

11. The method according to claim 10, wherein the arranging includes arranging the lens array and a light source such that the abnormal lens portion does not face a light emitting point in the light source.

12. A method of manufacturing an image forming apparatus, comprising:
manufacturing the optical apparatus by the method according to claim 9; and
arranging a developing unit configured to develop an electrostatic latent image formed by the optical apparatus as a toner image, and the optical apparatus.

13. An apparatus for evaluating a lens array, comprising:
a light source unit configured to emit measurement light;
a light receiving unit configured to receive the measurement light;
a driving unit configured to move at least one of the light source unit, the light receiving unit, and the lens array including a plurality of lens portions; and
a controller,
wherein the controller is configured to perform:
moving at least one of the light source unit, the light receiving unit, and the lens array in a first plane perpendicular to an optical axis direction such that at least one lens portion of the plurality of lens portions intersects an optical path of the measurement light from the light source unit by the driving unit;
causing the light receiving unit to receive the measurement light having passed through a predetermined lens portion of the at least one lens portion at a plurality of timings in the moving;
calculating a gradient at each position in a positional dependence of a light amount of the measurement light for the at least one lens portion received by the light receiving unit in the causing from time dependence of the light amount; and
evaluating the lens array based on information obtained in the calculating.

14. The apparatus according to claim 13, wherein the calculating includes calculating a line spread function from the positional dependence of the light amount.

15. The apparatus according to claim 14, wherein the calculating includes calculating a modulation transfer function from the line spread function.

16. The apparatus according to claim 13, wherein the calculating includes calculating the positional dependence of the light amount for the at least one lens portion from the time dependence of the light amount based on a speed of the moving in the moving.

17. The apparatus according to claim 13, wherein the calculating includes calculating a focal position at each position for the at least one lens portion from at least one of the gradient at each position in the positional dependence of the light amount for the at least one lens portion calculated from the time dependence of the light amount, a line spread function of the positional dependence of the light amount, and a modulation transfer function of the positional dependence of the light amount.

18. The apparatus according to claim 17, wherein the evaluating includes determining whether an abnormal lens portion is included in the at least one lens portion based on the calculated focal position of each of the at least one lens portion.

19. The apparatus according to claim 13, wherein the light receiving unit includes a stop configured to shield the measurement light having passed through a lens portion other than a predetermined lens portion among the plurality of lens portions.

20. The apparatus according to claim 13,
wherein the light source unit includes first and second light sources configured to emit first and second measurement lights, respectively,
wherein the light receiving unit includes first and second light receiving units configured to receive the first and second measurement lights, respectively,
wherein a distance between the first light receiving unit and the lens array on an optical path of the first measurement light and a distance between the second light receiving unit and the lens array on an optical path of the second measurement light are different from each other,
wherein the moving includes moving at least one of the light source unit, the light receiving unit, and the lens array in the first plane such that the at least one lens portion intersects the optical paths of the first and second measurement lights from the first and second light sources by the driving unit,
wherein the causing includes causing the first light receiving unit to receive the first measurement light having passed through the predetermined lens portion at a plurality of timings when the at least one lens portion intersects the optical path of the first measurement light, and causing the second light receiving unit to receive the second measurement light having passed through the predetermined lens portion at a plurality of timings when the at least one lens portion intersects the optical path of the second measurement light, and
wherein the calculating includes:
calculating first and second gradients at each position in positional dependences of first and second light amounts of the first and second measurement lights for the at least one lens portion received by the first and second light receiving units in the causing from time dependences of the first and second light amounts, respectively;
calculating a difference between the calculated first and second gradients at each position for the at least one lens portion; and
calculating a focal position at each position for the at least one lens portion from the calculated difference at each position for the at least one lens portion.
